(19) United States
(12) Patent Application Publication
(10) Pub. No.: US 2015/0163309 A1
(43) Pub. Date: Jun. 11, 2015

(54) SYSTEM FOR GENERATING A SOCIAL ANNOTATION

(71) Applicants: Sacha Christophe Arnoud, San Francisco, CA (US); Liron Yatziv, Sunnyvale, CA (US)

(72) Inventors: Sacha Christophe Arnoud, San Francisco, CA (US); Liron Yatziv, Sunnyvale, CA (US)

(73) Assignee: Google Inc., Mountain View, CA (US)

(21) Appl. No.: 13/566,871

(22) Filed: Aug. 3, 2012

(51) Int. Cl. H04W 4/02; H04L 29/08; H04B 5/00

(52) U.S. Cl. CPC H04L 67/18; H04W 4/02; H04L 67/104

(57) ABSTRACT

A machine-implemented method for generating a social annotation is provided. The method includes receiving, at an electronic device, data from a passive sensor, wherein the data comprises an internet link associated with a remote server. The method also includes determining a geographical location of the electronic device, and transmitting the determined geographical location of the electronic device to the remote server associated with the internet link, so as to generate a social annotation for a physical object associated with the determined geographical location.

### FIELD

The subject technology generally relates to social networks and, in particular, relates to a system for generating a social annotation of a physical asset using an electronic device.

### BACKGROUND

Digital assets, such as content displayed in a web page, may have content sharing features that are configured to broadcast the web page content to a user's social network. The content sharing features may be in the form of one or more clickable buttons displayed on the web page, with each button affiliated with a social network website. The user may then express a positive intent, such as an intent to share the web page content in the user's social network, by simply clicking on the appropriate “sharing” button.

### SUMMARY

The disclosed subject matter relates to a machine-implemented method for generating a social annotation. The method comprises receiving, at an electronic device, data from a passive sensor, wherein the data comprises an internet link associated with a remote server. The method also comprises determining a geographical location of the electronic device, and transmitting the determined geographical location of the electronic device to the remote server associated with the internet link, so as to generate a social annotation for a physical object associated with the determined geographical location.

The disclosed subject matter further relates to an electronic device for invoking a social annotation. The electronic device comprises a sensor communication module configured to receive from a passive sensor an internet link associated with a remote server. The system also comprises a geographical coordinates module configured to determine a geographical location of the electronic device. The system further comprises a confirmation module configured to invoke a social annotation from the remote server, wherein the social annotation is for a physical object associated with the determined geographic location.

The disclosed subject matter also relates to a system for generating a social annotation. The system comprises a communications module configured to receive a geographic location of an electronic device in response to a request from the communications module, the request initiated by activation of a passive sensor, wherein activation of the passive sensor directs the electronic device to an internet link hosted by the system. The system also comprises a query module configured to query a database using the received geographic location, wherein the database comprises physical object data. The system further comprises a social module configured to generate a social annotation for a physical object associated with the geographic location.

The disclosed subject matter also relates to a machine-readable medium encoded with executable instructions for generating a social annotation. The instructions comprise code for receiving, at a remote server, a geographic location of an electronic device in response to a request initiated by activation of a passive sensor, wherein activation of the passive sensor directs the electronic device to an internet link hosted by the remote server. The instructions also comprise code for querying a database using the received geographic location, wherein the database comprises physical object data. The instructions further comprise code for generating a social annotation for a physical object associated with the geographic location based on a selection received from the electronic device.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example distributed network environment which can provide for generating a social annotation for a physical asset.

FIG. 2 illustrates an example of a system for generating a social annotation for a physical asset.

FIG. 3 illustrates another example of a system for generating a social annotation for a physical asset.

FIG. 4 illustrates an example process by which a social annotation for a physical asset is generated.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Digital assets, such as content displayed in a web page, may have content sharing features that are configured to broadcast the web page content to a user's social network. The content sharing features may be in the form of one or more clickable buttons displayed on the web page, with each button affiliated with a social network website. The user may then express a positive intent, such as an intent to share the web page content in the user's social network, by simply clicking on the appropriate “sharing” button. If a user, however, wishes to express a positive intent for a physical asset, such as an intent to share content that is in the physical world (i.e., outside of a web page or other digital realm) in the user's social network, the user maybe limited in their ability to express their positive intent because the physical asset is generally incapable of being broadcasted in a social network.

The disclosed subject matter describes systems and techniques for generating a positive intent, such as a social annotation, for a physical asset. The system may include a passive sensor that may be disposed across a wide range of physical assets or objects, such as a business, museum, park, restaurant table, menu, consumer product, or any other physical object which a user may be interested in broadcasting in a social network. In response to an activation, data from the passive sensor is transmitted to an electronic device. The data includes a reference to an internet resource, such as an internet link associated with a remote server or service. The internet link may, for example, be a Uniform Resource Locator (“URL”), internet address, internet link, or internet port. Although a URL is used herein, it is understood that other internet links may be transmitted from the passive sensor to the electronic device. In response to receiving the URL from the passive sensor, the electronic device connects to the remote server and transmits geographical coordinates and user data to the remote server. In response to receiving the geographical coordinates from the electronic device, the remote server queries a database and transmits to the electronic device, physical asset data associated with the geographical coordinates. The physical asset data may comprise multiple points of interests or physical objects associated with the geographical coordinates. The physical asset data may be displayed on the electronic device for a user to select therefrom. After the user selects the appropriate physical asset, the electronic device transmits to the remote server, the selection. In response to the received selection, the remote server generates a social annotation for the selected physical asset in the user's social network.

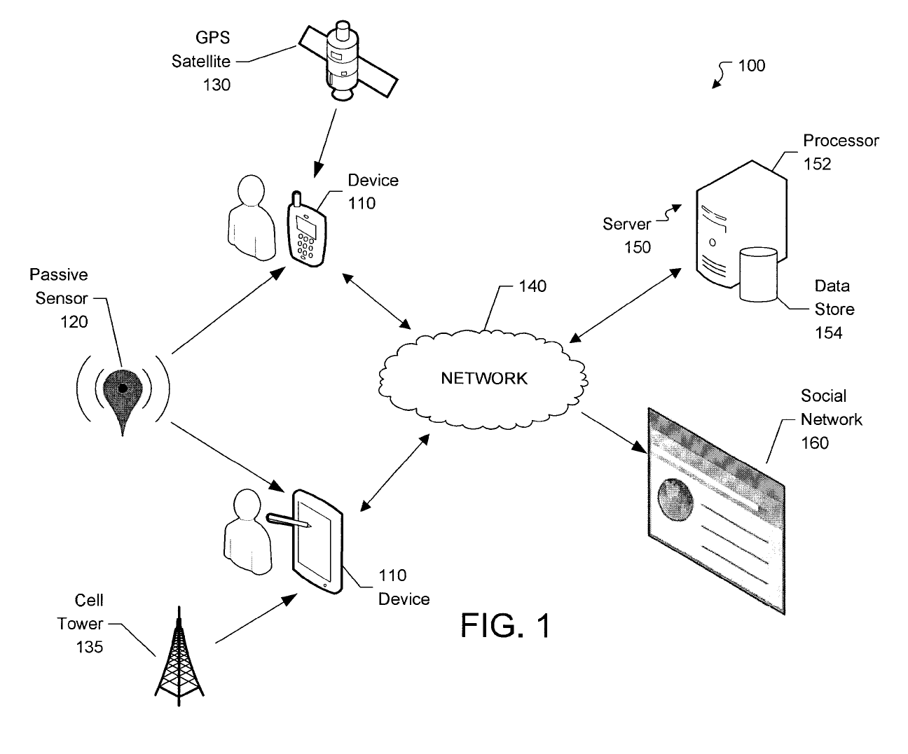

FIG. 1 illustrates an example distributed network environment which can provide for generating a social annotation for a physical asset. A network environment 100 includes a number of electronic devices 110 communicably connected to a remote server 150 by a network 140. Each of electronic devices 110 are configured to activate a passive sensor 120. The server 150 includes a processing device 152 and a data store 154. The processing device 150 executes computer instructions stored in the data store 154, for example, to generate the social annotation for the physical asset.

In example aspects, the passive sensor 120 may comprise an integrated circuit for storing and processing data and an antenna for transmitting the data. The passive sensor 120 may be configured to utilize proximity communication technology, without an internal power supply, for transmitting the data from the passive sensor 120 to the electronic device 110 and may, for example, be an RFID or Near Field Communication (“NFC”) tag. The passive sensor 120 may be activated by an electromagnetic field generated by the electronic device 110. The passive sensor 120 may have a working distance ranging from about 0 inches to 6 inches.

Alternatively, the passive sensor 120 may comprise an optical, Quick Response code (“QR”), or bar code tag that is configured to transmit data encoded in a visual pattern on the sensor. The optical sensor may be activated by scanning the optical sensor with the electronic device 110. The passive sensor 120 may contain data comprising descriptive information about an object, a company, person, and/or an internet link.

In some example aspects, the electronic devices 110 may be any machine with appropriate hardware/software to invoke a social annotation. The electronic devices 110 can be mobile devices (e.g., smartphones, tablet computers, PDAs, and laptop computers), portable media players, or other appropriate computing devices. In the example of FIG. 1, electronic device 110 is depicted as a smartphone or a tablet computer. Each of the electronic devices 110 are configured to communicate with the remote server (e.g., receive and transmit data), display physical asset data (e.g., display points of interest in a web browsing application), determine the geographic coordinates of the electronic device, and activate or read the passive sensor 120.

In some aspects the electronic device 110 may activate or read the passive sensor 120 without any special software or application. In another aspect, the electronic device 110 may be configured to load and display a web page using an embedded or native web browsing application, and thus, not require a special application or software.

Each electronic device 110 may determine its geographic coordinates by utilizing an internal or external GPS receiver, by utilizing assisted GPS (“A-GPS”), or by using a hybrid of both methods. The GPS receiver may use satellite GPS signals 130, while the A-GPS method may use one or more cell phone towers 135, to determine the location of the electronic device 110.

The server 150 may be any system or device having a processor, a memory, and communications capability for generating a social annotation for a physical asset. In some example aspects, the server 150 can be a single computing device such as a computer server. In other embodiments, the server 150 can represent more than one computing device working together to perform the actions of a server computer (e.g., cloud computing). The server 150 may be configured to communicate with the electronic devices 110, query the data store 154, transmit physical asset data, and generate the social annotation for the physical asset in the user's social network 160.

The network 140 can include, for example, any one or more of a cellular network, a satellite network, a personal area network (PAN), a local area network (LAN), a wide area network (WAN), a broadband network (BBN), the Internet, and the like. Further, the network 140 can include, but is not limited to, any one or more of the following network topologies, including a bus network, a star network, a ring network, a mesh network, a star-bus network, tree or hierarchical network, and the like.

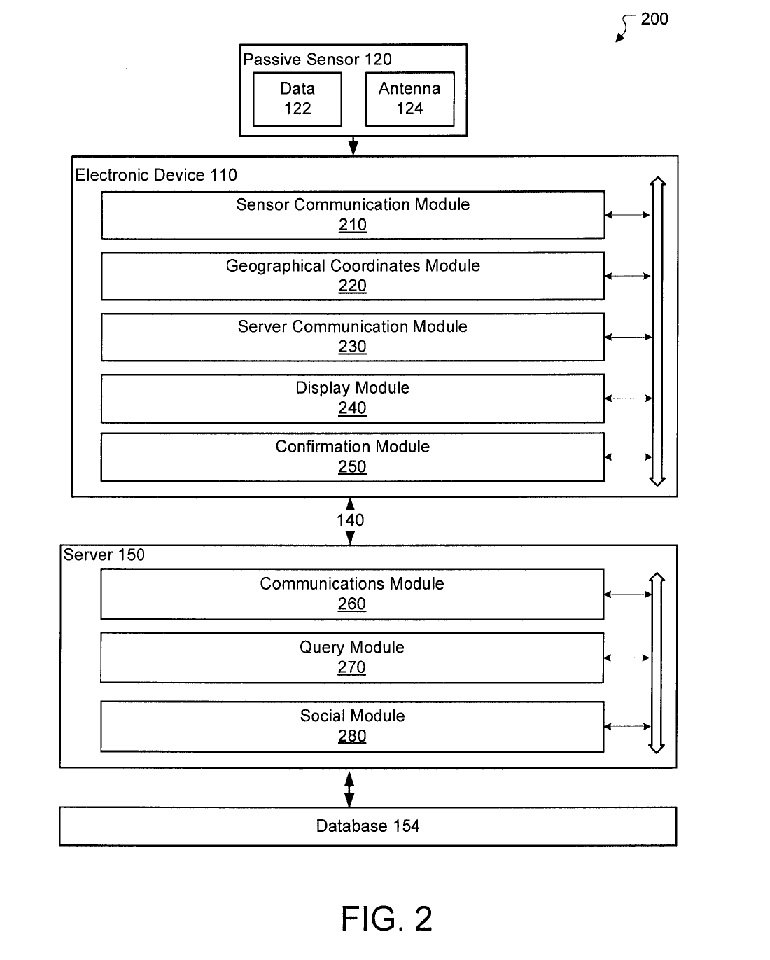

FIG. 2 illustrates an example of a system for generating a social annotation for a physical asset. The system 200 may be configured as a “zero-setup” system. The term “zero-setup” as used herein encompasses its plain and ordinary meaning, including, but not limited to a system capable of substantially performing its intended function without user intervention or special configuration by an installer or user of the system. The system 200 includes a passive sensor 120, which comprises data 122 and an antenna 124 for transmitting the data 122 to an electronic device 110. In the system 200, every passive sensor 120 is identical, in that the data 122 of each passive sensor 120 may contain the same internet link that is associated to a common remote server 150. The internet link may, for example, be a common URL. Although a common URL is used to describe the system 200, it is understood that any other type of common internet link may be contained in the data 122 of each passive sensor 120.

The electronic device 110 may include a sensor communication module 210, geographical coordinates module 220, server communication module 230, display module 240, and a confirmation module 250. These modules may be in communication with one another. The modules may be implemented in software (e.g., subroutines and code). Some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

The sensor communication module 210 is configured to activate the passive sensor 120 and receive from the passive sensor 120, the data 122, which in this example, comprises the URL associated with the server 150.

The geographical coordinates module 220 is configured to determine the geographical location and/or geographical coordinates of the electronic device 110 by using an internal or external GPS receiver, A-GPS, or by using a hybrid of both.

The server communication module 230 is configured to transmit and receive data to and from the server 150 using a network 140. In one aspect, in response to receiving the data 122 from the passive sensor 120, the server communication module 230 is configured to connect to the server 150 associated with the URL. In one example, the data transmitted by the server communication module 230 may include the determined geographical location, user information relating to a social network website, and/or a selection of a physical object.

Specifically, the server communication module 230 transmits to the server 150, the determined geographical location of the electronic device 110 and a user name for a social network website. The server communication module 230 also receives, from the server 150, physical asset data. As discussed further below, the physical asset data may comprise multiple points of interests or physical objects that are associated with the transmitted geographical location. The server communication module 230 is further configured to transmit the selection, by the user, of a physical object selected from the physical asset data.

The display module 240 is configured to display the received physical asset data. For example, the display module 240 may cause the physical asset data to be displayed on the electronic device 110 in a web browsing application. If the physical asset data comprises a single point of interest or physical object, then the confirmation module 250 may simply provide the user with an option to confirm whether the sole point of interest or physical object is the intended physical asset for invoking the social annotation. If the physical asset data comprises two or more points of interest or physical objects, then the confirmation module 250 may provide the user with an opportunity to select the appropriate physical asset for invoking the social annotation, as discussed below.

The confirmation module 250 is configured to invoke the social annotation for the selected physical object associated with the determined geographic location. For example, the confirmation module 250 may be configured to receive, from the user, the selected physical object. The selected physical object may be any physical object or a particular point of interest that the user intends to share in their social network. The selection may be based on user input, which may comprise a mouse-based input, a touch-based input, a button-based input, a keyboard-based input, or other suitable user input via an interface (e.g., a graphical user interface (GUI) associated with a web browser). As discussed above, the selected physical object is transmitted to the server 150 by the server communication module 230, thereby invoking the social annotation by the server 150, as discussed further below.

The server 150 may include a communications module 260, query module 270, and a social module 280. These modules may be in communication with one another. The modules may be implemented in software (e.g., subroutines and code). Some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

The communications module 260 is configured to receive and transmit data to and from the electronic device 110 via the network 140. In this example, the data received may include the geographic location of the electronic device 110, the user name for the social network website, and/or the selected physical object. The geographic location of the electronic device 110 may be provided to the communications module 260 by the geographical coordinates module 220, a location tracking service, or another service. For example, if the geographic location of the electronic device 110 was previously provided to a location tracking service, such as a service configured to continually or intermittently monitor the location of the electronic device 110, then the communications module 260 will transmit the request for the geographic location of the electronic device 110 to the location tracking service, instead of the electronic device 110. In another example, the user of the electronic device 110 may provide their geographic location to a service, such as by performing a “check in” and specifying the location of the electronic device 110 through user input. In this example, the communications module 260 will transmit the request for the geographic location of the electronic device 110 to the service associated with the “check in”, instead of the electronic device 110.

In some aspects, the data received from the electronic device 110, may be transmitted to the communications module 260 in response to a request from the communications module 260 that is initiated by activation of the passive sensor 120. The communications module 260 is also configured to transmit, to the electronic device 110, physical asset data associated with the geographic location, as described below.

The query module 270 is configured to query a data store 154 using the received geographic location. In some aspects, the data store 154 may include a GeoLookup table having geographical coordinates associated with physical objects. By using the received geographic location to query the GeoLookup table, the query module 270 generates the physical asset data which may comprise one or more points of interests or physical objects that are located at the geographic location of the electronic device 110. As described above, the physical asset data is transmitted to the electronic device 110 by the communications module 260, to enable the user to make a selection of a physical object from the physical asset data. In general, the selection represents the physical object or particular point of interest that the user intends to share in their social network. The selected physical object is received by the communications module 260.

The social module 280 is configured to generate the social annotation for the selected physical object using the user data received from the electronic device 110. The social annotation may comprise a broadcast of the physical object in the user's social network. The broadcast may express the user's intent to share the physical object with members of the user's social network.

In some aspects, a user must give permission for the electronic device 110 to transmit information about the user to the server 150. In particular, express permission must be given by the user to generate, store, maintain, or share, the geographical location of the electronic device 110, user data, or historical location data. The information about the user can be encrypted or otherwise protected from unauthorized access.

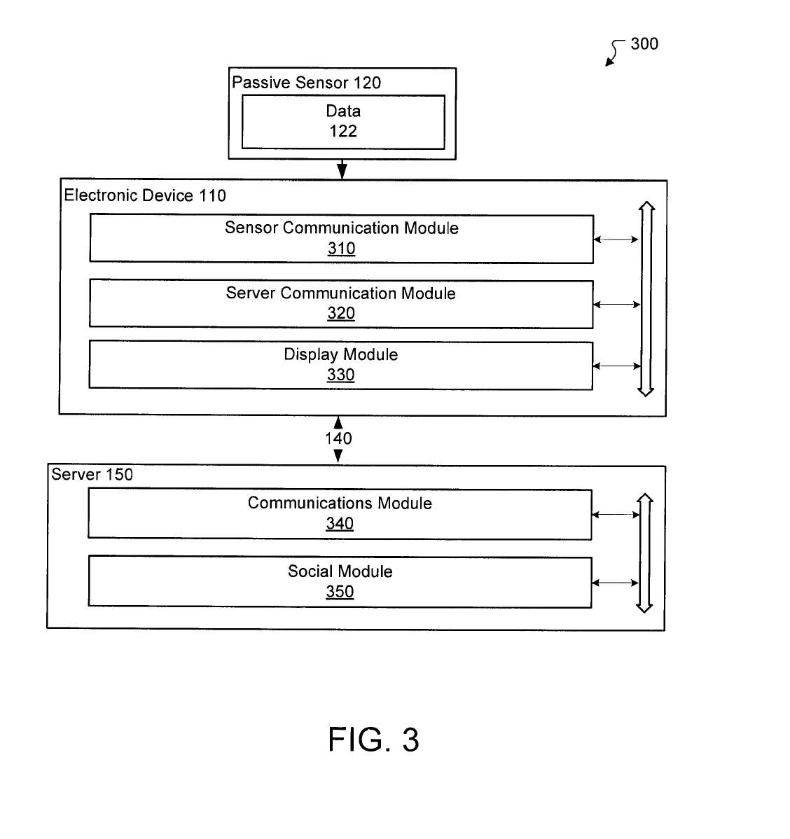

FIG. 3 illustrates another example of a system for generating a social annotation for a physical asset. The system 300 may be configured as a “non-zero-setup” system. The term “non-zero-setup” as used herein encompasses its plain and ordinary meaning, including, but not limited to a system that may first require some user intervention or special configuration by an installer or user of the system in order to perform its intended function. In this system 300, information about a physical asset may be entered into a server 150 by an installer.

In the “non-zero setup” system 300, each passive sensor 120 is unique. For example, each passive sensor 120 may be associated with a unique internet link associated with the server 150. The internet link may, for example, be a unique URL. Although a unique URL is used to describe the system 300, it is understood that any other type of unique internet link may be used. Activation of a passive sensor 120 causes the data 122 of the passive sensor to be transmitted to the electronic device 110, which in this example, would comprise the unique URL associated with the server 150.

Information about a physical asset may be entered into the server 150, via the unique URL, by an installer. To authenticate the installer, a unique code may be printed on each passive sensor 120 that the installer would first provide to the server 150 to gain access to a data entry mode. The unique code or identifier may be located on each passive sensor 120, and be hidden from the general public. For example, the unique code or identifier may be placed on a backside of the passive sensor 120 so as to not be visible by the general public.

After entry of the unique code or identifier, the installer may enter information about the physical asset, such as a description, location, or other information that the installer would like to attribute to the passive sensor 120. Subsequent activation of the passive sensor 120 by a user, would direct the electronic device 110 to the server 150 via the unique URL, thereby providing the additional information provided by the installer, to the user. In some aspects, because each passive sensor 120 is unique, multiple passive sensors may be placed in the same location and be attributed to different physical assets at that location (e.g., featured products at the location, cars in a showroom, etc.).

In another aspect, because the installer may provide geographical data about the physical asset to the server 150, the server 150 need not perform a query or GeoLookup to determine which physical assets may be located at the geographical location of the electronic device 110. The electronic device 110 may therefore only include a sensor communication module 310, server communication module 320, and a display module 330.

The sensor communication module 310 is configured to activate the passive sensor 120 and receive from the passive sensor the unique URL associated with the server 150.

The server communication module 320 is configured to connect to the server 150 associated with the unique URL, transmit user information relating to a social network to the server 150, and receive from the server 150 information about the physical asset.

The display module 330 is configured to display the received information about the physical asset in a web browsing application of the electronic device 110. Activation of the passive sensor 120 by the electronic device 110 thereby invokes the social annotation by the server 150, as discussed further below.

The server 150 may include a communications module 340 and a social module 350. The communications module 340 is configured to receive the user name for the social network website, and transmit to the electronic device 110 information about the physical asset initially provided by the installer.

The social module 350 is configured to generate the social annotation for the physical asset attributed to the passive sensor 120 by using the user data received from the electronic device 110. The social annotation may comprise a broadcast of the physical asset in the user's social network. The broadcast may express the user's intent to share the physical asset with members of the user's social network.

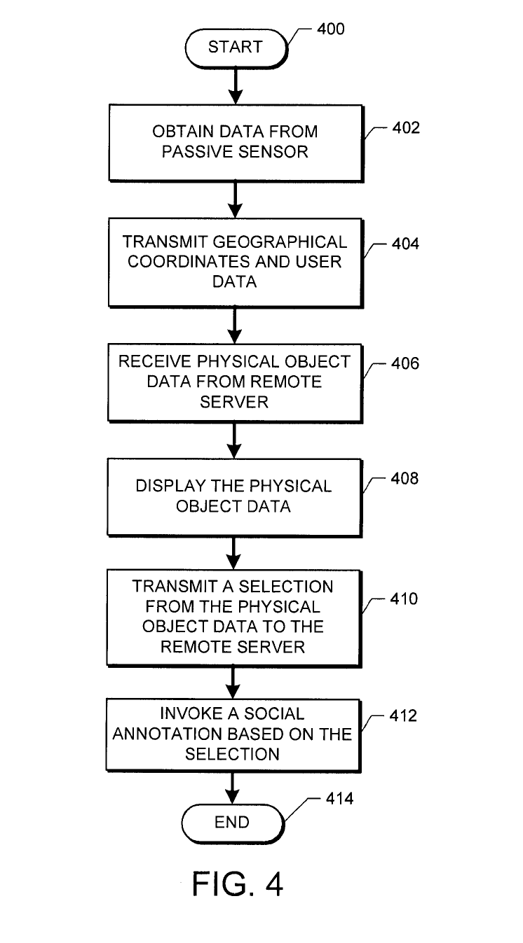

FIG. 4 illustrates an example process by which a social annotation for a physical asset is generated. Following start block 400, an electronic device obtains data from a passive sensor at step 402. The data may be transmitted by the passive sensor in response to activation of the passive sensor by the electronic device. In the “zero-setup” scenario, the data may comprise a URL associated with a server. The URL may direct the electronic device to the server associated with the URL and thereby cause the electronic device to load and open a web page affiliated with the server in a web browsing application. The server may request from the electronic device, geographic coordinates or a geographical location, and user data, such as a user name for a social network website. The electronic device may determine the geographical coordinates of its location using GPS, A-GPS, or a hybrid of both methods.

At step 404, the electronic device transmits to the server the determined geographical coordinates of the electronic device and the user data. The server uses the received geographical coordinates to determine whether there are any physical objects, such as points of interests, at the location based on the received geographical location. For example, the server may query a database, such as a GeoLookup table, having geographical coordinates associated with physical objects. Physical object data, representing physical objects that are located at or near the geographical location of the electronic device, are transmitted from the server to the electronic device.

At step 406, the physical object data is received by the electronic device. The physical object data may comprise a single physical object or point of interest, or a plurality of physical objects or points of interest that are located at or near the geographical location of the electronic device.

At step 408, the received physical object data is displayed on the electronic device for the user to select a physical object therefrom. The received physical object data may be displayed in a web browsing application of the electronic device. The user may select from the physical object data, the physical object that the user intends to share with members of the user's social network. The selection is based on user input.

At step 410, the selected physical object is transmitted by the electronic device to the server. The selection by the user may act as a confirmation that the user wishes to invoke the social annotation.

At step 412, in response to receiving the user's selection, the server broadcasts the selected physical object in the user's social network, by using the user data, and thereby generates the social annotation. The server, therefore, causes the selected physical object to be broadcasted in the user's social network based only on the user's activation of the passive sensor and selection thereafter of the appropriate physical object.

In one example, the broadcasted social annotation may express an intent to share the physical object with members of the user's social network. In another example, the broadcasted social annotation may comprise a “check-in.” In this example, the physical object may comprise a business, landmark, or other point of interest, which the user intends to share in their social network. Activation of the passive sensor by the user and selection of the point of interest thereafter, causes their presence at the point of interest to be broadcasted to members of the user's social network. The process then ends at end block 414.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

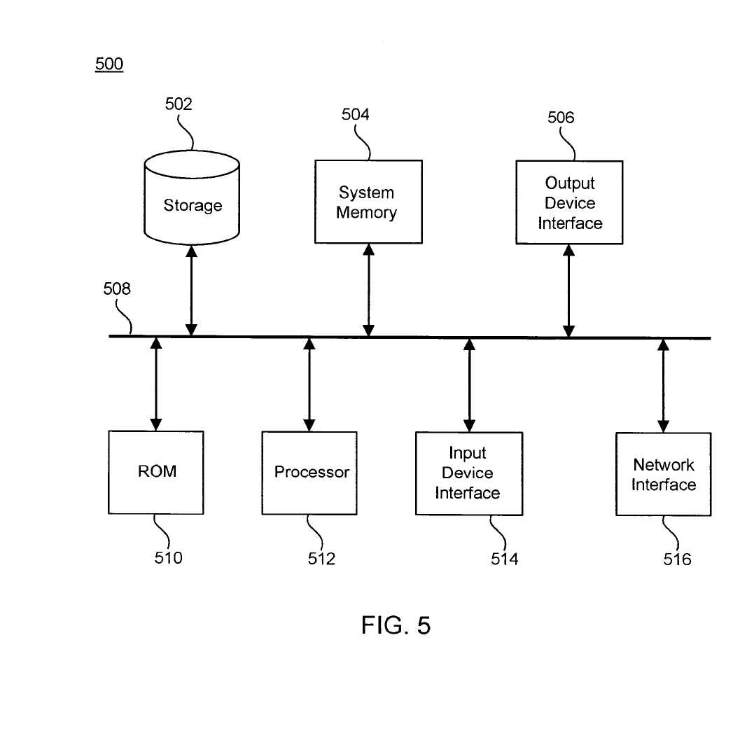

FIG. 5 conceptually illustrates an electronic system with which some implementations of the subject technology are implemented. Electronic system 500 can be a computer, phone, PDA, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for invoking or generating a social annotation for a physical object in accordance with some implementations. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Internet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration”. Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A machine-implemented method for generating a social annotation, the method comprising:
receiving, at an electronic device, data from a passive sensor, wherein the data comprises an internet link associated with a remote server;
determining a geographical location of the electronic device; and
transmitting the determined geographical location of the electronic device to the remote server associated with the internet link, so as to generate a social annotation for a physical object associated with the determined geographical location.

2. The method of claim 1, wherein the internet link comprises a URL.

3. The method of claim 1, further comprising receiving, at the electronic device, physical object data from the remote server, wherein the physical object data comprises at least one physical object that is based on the transmitted geographical location.

4. The method of claim 2, wherein the physical object data is displayed in a web browsing application on the electronic device.

5. The method of claim 2, further comprising transmitting a selection of the received physical object data to the server, wherein the selection is based on user input, and the selection causes the server to generate the social annotation.

6. The method of claim 1, further comprising transmitting user data to the remote server associated with the internet link, wherein the user data comprises a user name of a social network.

7. The method of claim 1, wherein the social annotation comprises a broadcast of the physical object in a user's social network, wherein the broadcast expresses an intent to share the physical object with members of the user's social network.

8. The method of claim 1, wherein the passive sensor comprises a near field communication tag.

9. The method of claim 1, wherein the physical object is a point of interest.

10. The method of claim 1, wherein the electronic device comprises a mobile device.

11. An electronic device for invoking a social annotation, the electronic device comprising:
a sensor communication module configured to receive from a passive sensor an internet link associated with a remote server;
a geographical coordinates module configured to determine a geographical location of the electronic device; and
a confirmation module configured to invoke a social annotation from the remote server, wherein the social annotation is for a physical object associated with the determined geographic location.

12. The electronic device of claim 11, further comprising a server communication module configured to transmit the geographical location to the remote server and receive physical object data from the remote server; wherein the physical object data comprises at least one physical object that is based on the transmitted geographical location.

13. The electronic device of claim 12, further comprising a display module configured to display the received physical object data.

14. The electronic device of claim 12, wherein the server communication module is further configured to transmit user information to the remote server associated with the internet link, wherein the user information comprises a user name for a social network.

15. The electronic device of claim 11, wherein the invoking the social annotation comprises transmitting to the remote server, a selection based on user input of the physical object associated with the determined geographic location.

16. A system for generating a social annotation, the system comprising: a communications module configured to receive a geographic location of an
electronic device in response to a request from the communications module, the request initiated by activation of a passive sensor, wherein activation of the passive sensor directs the electronic device to an internet link hosted by the system;
a query module configured to query a database using the received geographic location, wherein the database comprises physical object data; and
a social module configured to generate a social annotation for a physical object associated with the geographic location.

17. The system of claim 16, wherein the communications module is further configured to receive user data from the electronic device.

18. The system of claim 16, wherein the communications module is further configured to transmit to the electronic device the physical object data associated with the geographic location.

19. The system of claim 16, wherein the communications module receives the geographic location of the electronic device from a location tracking service.

20. The system of claim 16, wherein the social module generates the social annotation based on a selection received from the electronic device.

21. The system of claim 16, wherein the social annotation comprises a broadcast of the physical object in a user's social network, wherein the broadcast expresses an intent to share the physical object with members of the user's social network.

22. A machine-readable medium encoded with executable instructions for generating a social annotation, the instructions comprising code for:
receiving, at a remote server, a geographic location of an electronic device in response to a request initiated by activation of a passive sensor, wherein activation of the passive sensor directs the electronic device to an internet link hosted by the remote server;
querying a database using the received geographic location, wherein the database comprises physical object data; and
generating a social annotation for a physical object associated with the geographic location based on a selection received from the electronic device.

23. The computer-readable medium of claim 22, further comprising transmitting to the electronic device the physical object data associated with the geographic location.

24. The computer-readable medium of claim 22, wherein the social annotation comprises a broadcast of the physical object in a user's social network, wherein the broadcast expresses an intent to share the physical object with members of the user's social network.
